(19) United States
(12) Patent Application Publication
(10) Pub. No.: US 2005/0024354 A1
(43) Pub. Date: Feb. 3, 2005

(54) Display device

(75) Inventors: Kenichiro Hosoi, Tokyo (JP); Tetsuya Shigeta, Yamanashi-ken (JP); Junichi Usui, Fukuroi-shi (JP); Naruhiro Sato, Fukuroi-shi (JP); Tetsuro Nagakubo, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/882,145

(22) Filed: Jul. 1, 2004

(30) Foreign Application Priority Data
Jul. 4, 2003 (JP) 2003-192216

(51) Int. Cl. G09G 5/00

(52) U.S. Cl. 345/204

(57) ABSTRACT

A display device displays an image according to an input image signal on a display panel. The display device includes a plurality of display cells for creating the image from pixel signals with different emission colors according to the signal levels thereof. The display cells are arrayed in a matrix. The display device includes a brightness level calculation circuit for calculating emission brightness of the displayed image, and generating a brightness level signal that indicates the level of the emission brightness. The display device also includes an emission level correction circuit for correcting the signal levels of pixel signals included in the image signal for respective emission colors according to the brightness level signal.

### BACKGROUND OF THE INVENTION

1. Field of the Invention

The present invention relates to a display device using a self emitting flat display panel, such as a plasma display panel (hereafter called “PDP”) and an electroluminescence (hereafter called “EL”) panel.

2. Description of the Related Art

Recently display devices using self emitting flat display panels, such as PDPs and EL panels, are widely commercialized as so called wall-mounted TVs, and for example, Japanese Patent Kokai (Laid-Open Publication) No. 2003-29698 discloses a display device using a PDP. In such a display device, the emission brightness of display images is controlled and regulated by changing the number of emission sustain pulses (hereafter called “sustain pulses”) to be applied to the PDP during a predetermined period, such as a period of one field of the display image.

In such an emission brightness control and regulating method, when the average brightness level of the image signal supplied from an external image source (hereafter called “APL” (average pulse level)) is a predetermined threshold or more, ABL (Automatic Brightness Limiting) processing is executed for limiting emission brightness of the image depending upon the image signal displayed on the PDP. The main purpose of the ABL processing is to prevent image burn-in on the PDP and decrease power consumption of the PDP.

The detail of the emission brightness limiting and controlling method for the PDP, including the ABL processing, will be described below.

When APL is a predetermined threshold or more, the total number of sustain pulses to be applied to the PDP during one field period, that is the total number of sustain pulses to be applied to the subfields of one field period (hereafter called “total number of SUS”), is gradually decreased as the APL increases. When the APL is less than the threshold, the total number of SUS is maintained to be a predetermined constant value. In other words, when the APL is a brightness equal to or higher than the threshold, the total number of SUS is decreased as the APL increases, so as to decrease power consumption. Along with the decrease in the total number of SUS, the number of times of light emission from fluorescent elements, included in the display cells arrayed on the PDP, also decreases.

There are primarily three types of fluorescent element used for display cells on the PDP, namely, red fluorescent element, green fluorescent element, and blue fluorescent element. Red, green and blue colors are hereafter called R, G and B respectively. One pixel on the display screen is defined by a combination of display cells (combination of these three different fluorescent materials). Display cells emit different colors according to the signal levels of the pixel signals of the respective colors included in the image signal, and a color screen is displayed on the display panel.

However the afterglow characteristics of these fluorescent materials are different, depending on the colors of the fluorescent materials. In other words, the brightness ratio of each of the R, G and B fluorescent materials at emission is not constant if the number of times of emission changes. Therefore, even if the white balance is corrected at a predetermined number of times of emission on the basis of the brightness of each fluorescent material (i.e., the emission brightness of the display cell for each color is corrected) so that all the R, G and B display cells emit in combination white light, the white balance is lost if the number of times of emission of the fluorescent materials changes.

The losing of the white balance will be described below. For example, the afterglow characteristics of the G fluorescent material normally have a bigger value than those of the other fluorescent materials. Therefore as the APL increases and the total number of SUS decreases, that is, as the pulse density per unit time of sustain pulses decreases, the emission brightness of the G component relatively increases and makes the display screen of the PDP greenish. So if the white balance correction is set in advance based on the pulse density at an intermediate value of the APL, then the entire screen becomes greenish even if the APL increases and the pulse density decreases to attempt to create an entirely white screen. If the APL decreases and the pulse density increases to reduce the white area on the screen, on the other hand, the entire screen becomes reddish.

By the fluctuation of the pulse density due to the change of the APL, the drive current of the sustain pulse drive circuit also changes. Such a change of the drive current causes a distortion of pulse waveforms to be supplied to the PDP by the influence of switching resistance and the drive impedance of the sustain pulse drive circuit. As a result, the emission brightness of the display cells changes. This further increases the loss of white balance, in addition to the difference caused by the above mentioned afterglow characteristics for each fluorescent material.

### SUMMARY OF THE INVENTION

One object of the present invention is to provide a display device which can maintain the white balance even if the brightness of the display image changes.

According to one aspect of the present invention, there is provided an improved display device for displaying an image on a display panel in accordance with an input image signal. The display panel includes a plurality of display cells, and these display cells are divided into a plurality of groups. Each display cell group serves as a pixel. The display cell groups are arranged in a matrix. The display cells in each group have different emission colors. Emission of respective colors are determined by signal levels of pixel signals included in the input image signal. The display device includes a brightness level calculation unit for calculating emission brightness of the image and generating a brightness level signal that represents a level of the emission brightness. The display device also includes an emission level correction unit for correcting the signal levels of the pixel signals included in the image signal for the respective emission colors based on the brightness level signal.

According to another aspect of the present invention, there is provided an improved drive method for a display device. The display device is adapted to display an image on a display panel in accordance with an input image signal. The display panel includes a plurality of display cells, and these display cells are divided into a plurality of groups. Each display cell group serves as a pixel. The display cell groups are arranged in a matrix. The display cells in each group have different emission colors, and emission of respective colors are determined by signal levels of pixel signals included in the input image signal. A display period of each field of the input image signal is divided into of a plurality of subfields. A predetermined number of sustain pulses is set for each subfield. Each of the display cells is set into a lit mode or an unlit mode in each subfield in accordance with the input image signal. The signal levels of the pixel signals included in the image signal are corrected for the respective emission colors based on a total number of sustain pulses repeatedly applied in the subfield or a period of the sustain pulses.

These and other objects, aspects and advantages of the present invention will become apparent to those skilled in the art from the following detailed description and appended claims when read and understood in conjunction with the attached drawings.

### BRIEF DESCRIPTION OF THE DRAWINGS

FIG. 1 is a block diagram depicting a general configuration of a display device according to a first embodiment of the present invention;

FIG. 2 is a block diagram depicting a display data generation section in the display device shown in FIG. 1;

FIG. 3 depicts drive sequences of a PDP shown in FIG. 1;

FIG. 4 is a flow chart depicting operation in the display data generation section of FIG. 2;

FIG. 5 illustrates the operation in a second correction circuit shown in FIG. 2;

FIG. 6 is a block diagram of another display data generation section according to a second embodiment of the present invention;

FIG. 7 is a flow chart depicting the operation in the display data generation section shown in FIG. 6; and

FIG. 8 is a block diagram of another display data generation section according to a third embodiment of the present invention.

### DETAILED DESCRIPTION OF THE INVENTION

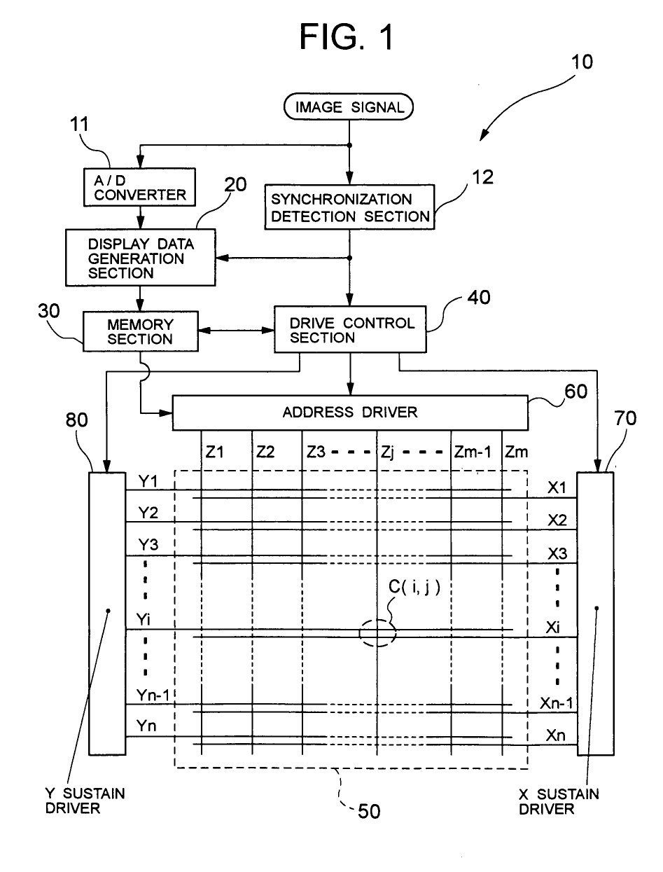

The display device 10 according to the first embodiment of the present invention is shown in FIG. 1, and includes an analog-to-digital converter 11 (hereafter called “AD converter 11”), a synchronization detection section 12, a display data generation section 20, an image memory section 30, a driver control section 40, a PDP 50, an address driver circuit 60, an X sustain driver circuit 70 and a Y sustain driver circuit 80. The display data generation section 20 mainly corresponds to the brightness level calculation means and emission level correction means set forth in the appended claims.

In FIG. 1, the AD converter 11 is a circuit for converting the image signals supplied from an image source (not illustrated), such as a digital broadcast receiver or video disk player, into digital pixel signals having a predetermined bit length at a predetermined sampling rate. The synchronization detection section 12 is a circuit for detecting the horizontal and vertical synchronization signals included in the image signals, and notifying such synchronization timing to the display data generation section 20 and the driver control section 40.

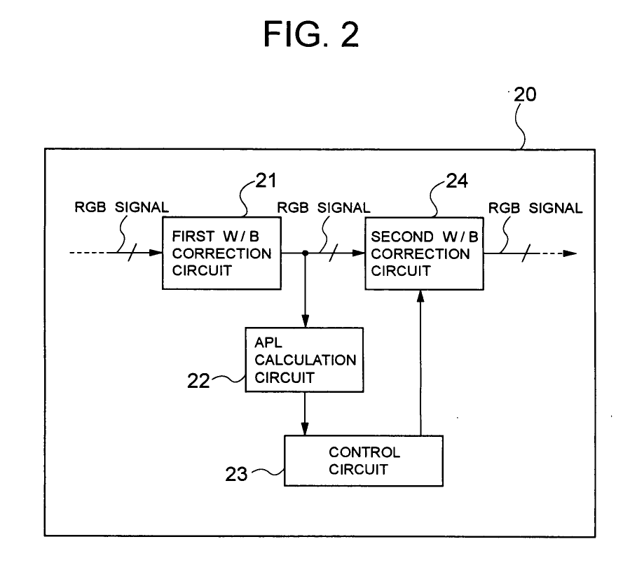

The display data generation section 20 is a circuit for generating the display pixel signals to be displayed on the display screen by performing a predetermined processing on the digital pixel signals supplied from the AD converter 11. FIG. 2 shows the configuration of the display data generation section 20.

As illustrated in FIG. 2, the display data generation section 20 includes a first white balance correction circuit 21 (hereafter called “first correction circuit 21”), APL calculation circuit 22, control circuit 23, and second white balance correction circuit 24 (hereafter called “second correction circuit 24”). The APL calculation circuit 22 and control circuit 23 mainly correspond to the brightness level calculation means in the appended claims, and the first correction circuit 21, second correction circuit 24 and control circuit 23 mainly correspond to the emission level correction means in the appended claims. The first correction circuit 21 corresponds to the first correction means, and the second correction circuit 24 corresponds to the second correction means.

In FIG. 2, the first correction circuit 21 is a circuit for correcting the white balance of the display screen by correcting the signal levels of the digital pixel signals for respective emission colors using the correction values stored in the correction value table. The correction value table is prepared in advance. The APL calculation circuit 22 is a circuit for calculating the emission brightness of the display image, generating the brightness level signal which indicates the brightness level, and supplying the brightness level signal to the control circuit 23. The control circuit 23 includes a microcomputer, a memory circuit having a RAM and a ROM, and peripheral circuits thereof (none of these are illustrated) for controlling the entire display data generation section 20. The second correction circuit 24 is a circuit for adjusting the white balance of the display screen by performing predetermined arithmetic processing on the signal levels of the digital pixel signals, and correcting the signal levels for respective emission colors. In addition to these circuits, the display data generation section 20 includes a multi-grayscale processing circuit and various circuits required for creating display image data, such as a dither processing circuit, but the block diagram in FIG. 2 shows only the elements related to the embodiment of the present invention.

The image memory section 30 is an image memory circuit for temporarily storing display pixel signals supplied from the display data generation section 20 for one field to several fields, for example. The display pixel signals stored in the image memory section 30 are supplied to the address driver 60 based on timing signals supplied from the driver control section 40.

The driver control section 40 generates control signals for driving the address driver and the X and Y sustain drivers based on the synchronization timing signals included in the image signals, and supplies the control signals to the respective drivers.

The PDP 50 is a display screen for displaying images, and includes row electrodes X₁ to Xₙ and row electrodes Y₁ to Yₙ. Each pair of row electrodes Xᵢ and Yᵢ defines each display line (first row to n-th row) of one screen. In the PDP 50, column electrodes Z₁, to Zₘ are also provided corresponding to vertical lines (first column to m-th column) of one screen. The column electrodes extend perpendicularly to the row electrode pairs. The dielectric layer and the discharge space layer, which are not illustrated, are sandwiched between the column electrodes and the row electrode pairs. One display cell C_{(i, j)} is formed at a cross-section of a pair of row electrodes (Xᵢ, Yᵢ) and one column electrode Zⱼ.

The electrodes of the PDP 50 are connected to the address driver 60, X sustain driver 70 and Y sustain driver 80, and these driver circuits are controlled by instructions from the driver control section 40.

The Y sustain driver 80 generates various drive pulses including the reset pulse and sustain pulse, and applies these pulses to the row electrodes Y₁ to Yₙ at a predetermined timing. The X sustain driver 70 also generates various drive pulses and applies these pulses to the row electrodes X₁ to Xₙ at a predetermined timing. The address driver 60 generates the pixel signal pulses corresponding to the first to n-th rows of the display screen from the display pixel signals supplied from the image memory section 30 based on the timing signals from the driver control section 40, and sequentially applies these pulses to the column electrodes Z₁ to Zₙ.

Inside each of the X sustain driver 70, Y sustain driver 80 and address driver 60, a pulse generation circuit (not illustrated) for generating various drive pulses is disposed for each row and column electrode of the PDP 50.

Now the general operation of the PDP 50 and each driver circuit will be described.

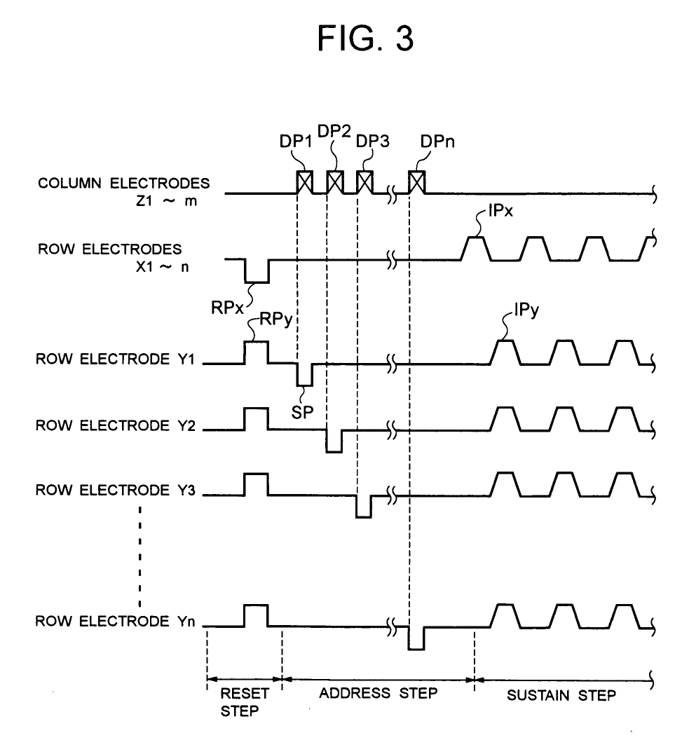

The Y sustain driver 80 generates reset pulses PR_{y} with a positive voltage as shown in the timing chart in FIG. 3, and applies these pulses to the row electrodes Y₁ to Yₙ simultaneously. At the same time, the X sustain driver 70 generates reset pulses RPₓ with a negative voltage, and applies these pulses to all the row electrodes X₁ to Xₙ simultaneously.

By applying these reset pulses RPₓ and RP_{y} simultaneously, all the display cells of the PDP 50 are discharged and excited, and charged particles are generated. After the discharge ends, a certain amount of wall charges are formed uniformly in the dielectric layers of all the display cells. This processing is called the “reset step”.

After the reset step ends, the address driver 60 generates pixel signal pulses DP₁ to DPₙ according to the pixel signals of the first row to n-th row of the screen. The address driver 60 sequentially applies these pixel signal pulses to the column electrodes Z₁ to Zₘ, as shown in FIG. 3. The Y sustain driver 80, on the other hand, generates scan pulses SP with a negative voltage according to the respective application timing of the pixel signal pulses DP₁ to DPₙ. The Y sustain driver 80 sequentially applies these scan pulses SP to the row electrodes Y₁ to Yₙ at the timing shown in FIG. 2.

Out of the display cells which belong to the row electrodes to which the scan pulse SP is applied, a discharge occurs in those display cells to which the pixel signal pulses DP with a positive voltage are simultaneously applied. In such display cells, most of the wall charges are lost. In the display cells to which the scan pulse SP is applied but the pixel signal pulse DP with a positive voltage is not applied, on the other hand, a discharge does not occur so that the wall charges remain in these display cells. At this time, the display cells whose wall charges remain become emission discharge cells, and the display cells whose wall charges are lost become non-emission discharge cells. This processing step is called the “address step”.

When the address step ends, the Y sustain driver 80 continuously applies the sustain pulses IP_{y} with a positive voltage to the row electrodes Y₁-Yₙ, as shown in FIG. 3. The X sustain driver 70 continuously applies the sustain pulses IPₓ with a positive voltage to the row electrodes X₁ to Xₙ at a timing shifted from the application timing of the sustain pulses IP_{y}. During the period while the sustain pulses IPₓ and IP_{y} are alternately applied, discharge emission is repeated in the emission discharge cells where the wall charges remain, and the emission status of these display cells is maintained. This processing step is called the “sustain step”.

In the display device 10 shown in FIG. 1, the above described series of processing steps are repeated for each subfield or each field of the display image.

Now operation of the display device 10 according to the present embodiment will be described, focusing mainly on the processing in the display data generation section 20.

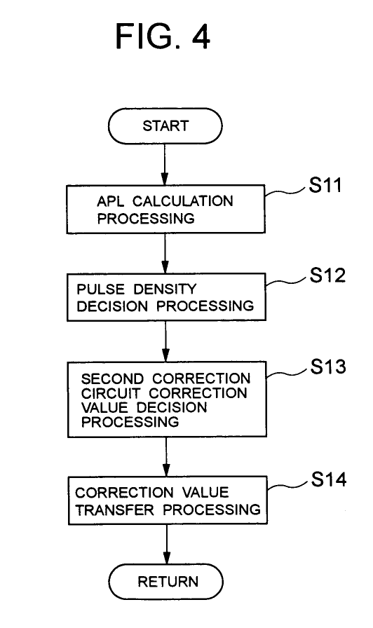

An overview of the program for such processing is shown in the flow chart in FIG. 4. This program has been stored in the ROM of the control circuit 23 in advance, and the microcomputer in the control circuit 23 executes this program one step at a time, synchronizing with the internal clock signals. The program shown in FIG. 4 may be started up for each screen synchronizing with the detection timing of the vertical synchronization signals from the synchronization detection section 12, or may be started up according to a predetermined timing.

When the program shown in FIG. 4 is started up, the microcomputer of the control circuit 23 (hereafter simply called “microcomputer”) sends instructions to the APL calculation circuit 22, and has this circuit calculate the APL of the image data which is output from the first correction circuit 21 in step S11. For the image data which is output from the first correction circuit 21, the first white balance correction has been performed by the correction value table included in the first correction circuit.

The white balance correction by the correction value table is executed according to the following procedure. At first, the correction values which have been stored in the addresses corresponding to R, G and B pixel signal values to be supplied to the first correction circuit 21 are extracted from the correction value table in which the correction values are set in advance based on the emission characteristics of the display panel. Then correction is made by performing a weighing on the signal level of the pixel signal for each color using the extracted correction values.

Upon receiving the APL of the image data from the APL calculation circuit 22, the microcomputer moves to the next step S12, and decides the total number of SUS corresponding to the acquired APL and the pulse density of the sustain pulses in the sustain step.

Then the microcomputer moves to the next step S13 and decides correction values for the second correction circuit 24. Specifically, based on the total number of SUS and the pulse density determined in step S12, the microcomputer calculates the gain value to multiply and the offset value to be superimposed for each of the R, G and B pixel signals. It should be noted that the gain value and offset value may be obtained using a prepared numerical table on the basis of the total number of SUS and pulse density. Alternatively, a predetermined function may be established in advance between the total number of SUS, pulse density, gain value and offset value, so as to use this function for calculation of the gain value and offset value.

Upon finishing each correction value decision processing in step S13, the microcomputer moves to the next step S14, and transfers the calculated correction values to the second correction circuit 24. The second correction circuit 24, which has received the correction values from the control circuit 23, performs the second white balance correction for the pixel signals for the colors using these correction values.

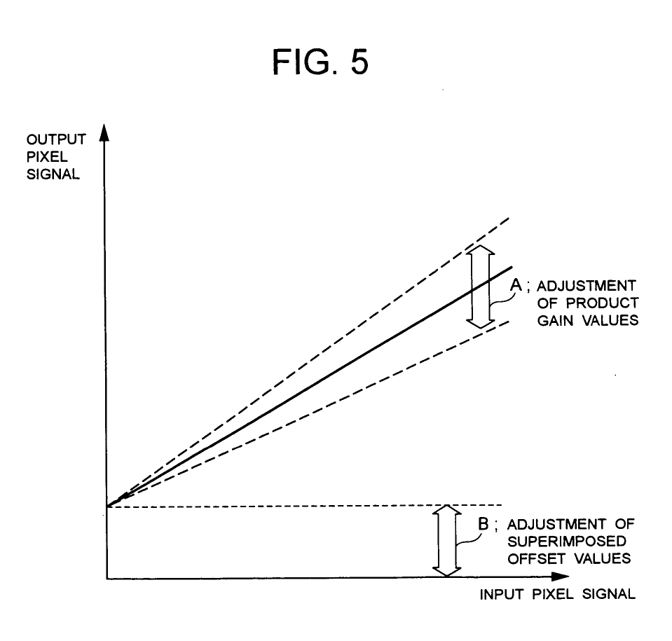

FIG. 5 shows the principle of the white balance correction in the second correction circuit 24. For example, as indicated by the white arrow A in FIG. 5, the signal level of the output pixel signal may be adjusted by multiplying the input pixel signal by the gain value transferred from the control circuit 23. Alternatively, as indicated by the white arrow B in FIG. 5, the signal level of the output pixel signal may be adjusted by superimposing the transferred offset value onto the input pixel signal. Such correction processing is executed for each of the R, G and B pixels.

In the present embodiment, the processing described above is executed for each display screen. Therefore, even if the brightness of the display screen changes, appropriate white balance correction is executed according to the most recent brightness.

Now the second embodiment of the present invention will be described. Since the only difference of the second embodiment from the first embodiment is the configuration of the display data generation section 20, this different portion will be described. Similar reference numerals are used in the first and second embodiments to designate similar elements.

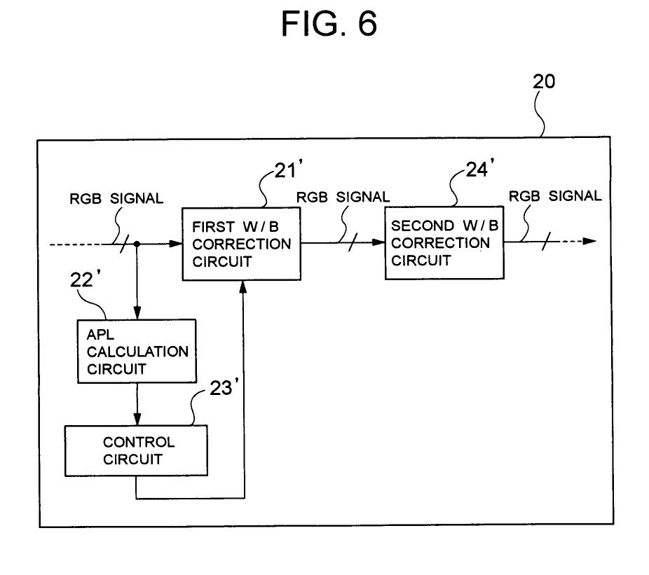

As FIG. 6 shows, the display data generation section 20 in the second embodiment includes a first white balance correction circuit 21′ (hereafter called “first correction circuit 21′”), APL calculation circuit 22′, control circuit 23′ and second white balance correction circuit 24′ (hereafter called “second correction circuit 24′”). The APL calculation circuit 22′ and control circuit 23′ mainly correspond to the brightness level calculation means in the appended claims, and the first correction circuit 21′, second correction circuit 24′ and control circuit 23′ mainly correspond to the emission level correction means in the appended claims. The first correction circuit 21′ corresponds to the first correction means and the second correction circuit 24′ corresponds to the second correction means respectively.

In FIG. 6, the first correction circuit 21′ is a circuit for correcting the white balance of the display screen by adjusting the signal level of the digital pixel signal for each emission color using the correction values stored in the correction value table. The APL calculation circuit 22′ is a circuit for calculating the emission brightness of the display image, generating the brightness level signal which indicates the brightness level, and supplying the brightness level signal to the control circuit 23′. The control circuit 23′ includes a microcomputer, a memory circuit having a RAM and a ROM, and peripheral circuits thereof (none of these are illustrated), and operates and controls the entire display data generation section 20. The second correction circuit 24′ is a circuit for correcting the white balance of the display screen by performing predetermined arithmetic processing on the signal levels of the digital pixel signals, and correcting the signal levels for the respective emission colors. For the other circuits for generating display image data included in the display data generation section 20, description is omitted.

Now operation of the display device 10 according to the second embodiment will be described, focusing mainly on the processing in the display data generation section 20.

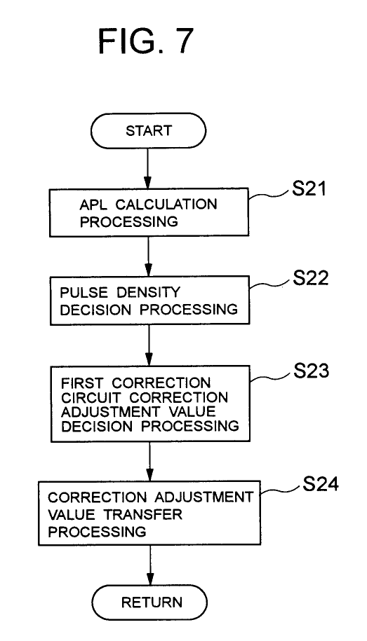

An overview of the program for such processing is shown in the flow chart in FIG. 7. This program has been stored in the ROM of the control circuit 23′ in advance, and the microcomputer in the control circuit 23′ executes this program one step at a time, synchronizing with the internal clock signals. The program shown in FIG. 7 may be started up for each screen synchronizing with the detection time of the vertical synchronization signals from the synchronization detection section 12, or may be started up according to a predetermined timing.

When the program shown in FIG. 7 is started up, the microcomputer of the control circuit 23′ (hereafter simply called “microcomputer”) sends predetermined instructions to the APL calculation circuit 22′, and has this circuit calculate the APL of the image data which is introduced to the first correction circuit 21′ in step S21.

Upon receiving the APL of the image data from the APL calculation circuit 22′, the microcomputer moves to the next step S22, and determines the total number of SUS corresponding to the acquired APL and the pulse density of the sustain pulses in the sustain step.

Then the microcomputer moves to the next step S23, and determines the correction adjustment values for the correction values of the first correction circuit 21′. Specifically, based on the total number of SUS and pulse density decided in step S22, the microcomputer calculates the correction adjustment values for adjusting the correction values which are stored in the correction value table included in the first correction circuit 21′.

As described above, the correction values which are set based on the emission characteristics of the display panel are stored in the correction value table. In the present embodiment, adjustment according to the brightness change of the display screen is further added to the correction values, so as to improve the white balance correction effect in the first correction circuit 21′.

The correction adjustment values may be obtained from a numerical table on the basis of the total number of SUS and pulse density. Alternatively, predetermined functions are defined among the total number of SUS, pulse density and adjustment value, so as to use these functions for calculation of the adjustment values.

Upon finishing the correction adjustment value decision processing in step S23, the microcomputer moves to the next step S24, and transfers the calculated correction adjustment values to the first correction circuit 21′. The first correction circuit 21′, which receives the correction adjustment values from the control circuit 23′, adjusts the correction values stored in the correction value table using these correction adjustment values, and corrects the white balance for the pixel signals of the respective colors using the adjusted (modified) correction values.

In the present embodiment, predetermined fixed values are prepared for the gain value and the offset value to be used for correction of the white balance in the second correction circuit 24′. The white balance correction processing in the first correction circuit 21′ and the second correction circuit 24′ is the same as the first embodiment, so that description thereof will be omitted.

In this second embodiment, the processing described above is executed for each display screen. Therefore, even if the brightness of the display screen changes, appropriate white balance correction is executed according to the current screen brightness.

Now the third embodiment of the present invention will be described. Since the only difference of the third embodiment from the first and second embodiments is the configuration of the display data generation section 20, this different portion will be described. Similar reference numerals are used in the first, second and third embodiments to designate similar elements.

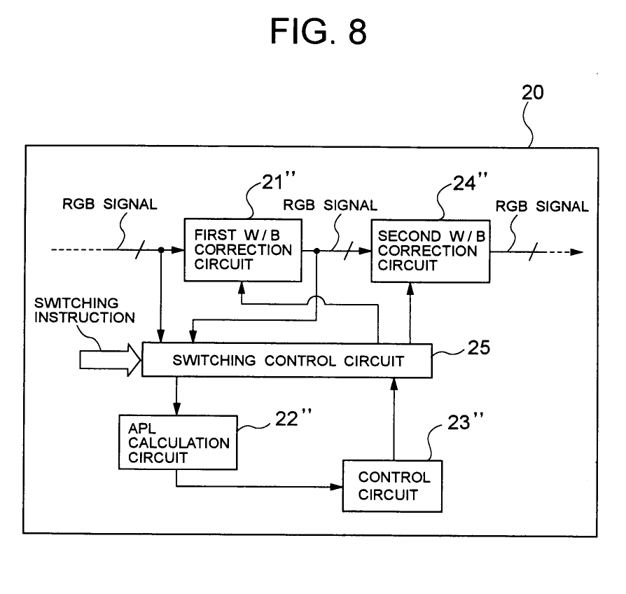

As depicted in FIG. 8, the display data generation section 20 in the third embodiment includes a first white balance correction circuit 21″ (hereafter called “first correction circuit 21″”), APL calculation circuit 22″, control circuit 23″, second white balance correction circuit 24″ (hereafter called “second correction circuit 24″”) and a switching control circuit 25. The APL calculation circuit 22″ and control circuit 23″ mainly correspond to the brightness level calculation means in the appended claims, and the first correction circuit 21″, second correction circuit 24″ and control circuit 23″ mainly correspond to the emission level correction means in the appended claims. The switching control circuit 25 corresponds to the operation switching means, the first correction circuit 21″ corresponds to the first correction means, and the second correction circuit 24″ corresponds to the second correction means.

In FIG. 8, the first correction circuit 21″ corrects the white balance of the display screen by correcting the signal levels of the digital pixel signals for the emission colors using the correction values stored in the correction value table. The APL calculation circuit 22″ is a circuit for calculating the emission brightness of the display screen, generating the brightness level signal which indicates the brightness level, and supplying the brightness level signal to the control circuit 23′. The control circuit 23″ includes a microcomputer, a memory circuit having a RAM and a ROM, and peripheral circuits thereof (none of these are illustrated) for controlling the entire display data generation section 20. The second correction circuit 24″ is a circuit for correcting the white balance of the display screen by performing arithmetic processing on the signal levels of the digital pixel signals, and correcting the signal levels for the emission colors. The switching control circuit 25 switches the operation of the display data generation section 20 in response to switching instructions.

Now operation of the display data generation section 20 according to the third embodiment will be described. This embodiment is characterized in that operation of the display data generation section 20 is switched by the switching instructions which the user enters to the switching control circuit 25 from an operation panel (not illustrated) of the display device, for example.

Specifically, if the operation of the first embodiment is selected by the switching instructions, the switching control circuit 25 connects the input signal directed to the first correction circuit 21″ to the APL calculation circuit 22″, and connects the output signal from the control circuit 23″ to the second correction circuit 24″. By these connections, the processing operation described in the first embodiment is executed.

If the operation of the second embodiment is selected by the switching instructions, the switching control circuit 25 connects the output signal from the first correction circuit 21″ to the APL calculation circuit 22″, and connects the output signal from the control circuit 23″ to the first correction circuit 21″. By these connections, the processing operation described in the second embodiment is executed.

In the third embodiment, appropriate white balance correction is performed according to the brightness change of the display screen, based on the selected processing operation.

The present invention is not limited to the above described embodiments. For instance, in the first to third embodiments, it is not necessary to always include the first correction circuit and the second correction circuit, and the display data generation section 20 may include only one of these correction circuits.

In the above described embodiments, the total number of SUS and the density of sustain pulses in one field period are determined based on the average brightness in one field period of the image signal, and the R, G and B signals are corrected (adjusted) on the basis of the total number of SUS and sustain pulse density. However, the present invention is not limited in this regard. The present invention can be applied as long as the R, G and B signals are respectively corrected to adjust the white balance of the display image, when the density of the sustain pulses (i.e., the period of sustain pulses which are repeatedly applied in the sustain step of each subfield) changes.

For example, when the total number of SUS and the sustain pulse density are changed according to the frequency of the vertical synchronization signals in the input image signals, the R, G and B signals may be respectively corrected correspondingly so as to adjust the white balance of the display image.

This application is based on a Japanese patent application No. 2003-192216 filed on Jul. 4, 2003 and the entire disclosure thereof is incorporated herein by reference.

1. A display device for displaying an image on a display panel in accordance with an input image signal, the display panel including a plurality of display cells, the plurality of display cells being divided into a plurality of groups of display cells, each said group serving as a pixel, the plurality of display cell groups being arranged in a matrix, the display cells in each said group having different emission colors, emission of respective colors being determined by signal levels of pixel signals included in the input image signal, the display device comprising:
brightness level calculation means for calculating emission brightness of said image and generating a brightness level signal that represents a level of said emission brightness; and
emission level correction means for correcting the signal levels of the pixel signals included in said image signal for the respective emission colors based on said brightness level signal.

2. The display device according to claim 1, wherein said emission level correction means comprises first correction means for correcting the signal levels of the pixel signals included in said image signal for the emission colors based on correction values stored in a correction value table.

3. The display device according to claim 2, wherein said brightness level calculation means generates said brightness level signal based on the image signal introduced to said first correction means, and said first correction means adjusts the correction values stored in said correction value table based on said brightness level signal.

4. The display device according to claim 2, wherein said emission level correction means further comprises second correction means for correcting the signal levels of the pixel signals included in said image signal for the emission colors by multiplying a gain value and superimposing an offset value to each of the signal levels of said pixel signals.

5. The display device according to claim 1, wherein said emission level correction means comprises second correction means for correcting the signal levels of the pixel signals included in said image signal for the emission colors by multiplying a gain value and superimposing an offset value to each of the signal levels of said pixel signals.

6. The display device according to claim 4, wherein said brightness level calculation means generates said brightness level signal based on the image signal outputted from said first correction means, and said second correction means adjusts at least one of said gain value and said offset value based on said brightness level signal.

7. The display device according to claim 1, wherein each said display cell group includes a red display cell to emit red light, a green display cell to emit green light, and a blue display cell to emit blue light, and said read, green and blue display cells emit the read light, green light and blue light in accordance with the signal levels of the pixel signals included in said image signal.

8. A method of driving a display device, the display device being adapted to display an image on a display panel in accordance with an input image signal, the display panel including a plurality of display cells, the plurality of display cells being divided into a plurality of groups of display cells, each said group serving as a pixel, the plurality of display cell groups being arranged in a matrix, the display cells in each said group having different emission colors, emission of respective colors being determined by signal levels of pixel signals included in the input image signal, the method comprising:
dividing a display period of one field of the input image signal into of a plurality of subfields;
setting a predetermined number of sustain pulses for each of said plurality of subfields;
setting each of the display cells into a lit mode or an unlit mode in each said subfield in accordance with the input image signal; and
correcting the signal levels of the pixel signals included in said image signal for the respective emission colors based on a total number of sustain pulses to be repeatedly applied in each said subfield or a period of said sustain pulses.

9. A display device for displaying an image on a display panel in accordance with an input image signal, the display panel including a plurality of display cells, the plurality of display cells being divided into a plurality of groups of display cells, each said group serving as a pixel, the plurality of display cell groups being arranged in a matrix, the display cells in each said group having different emission colors, emission of respective colors being determined by signal levels of pixel signals included in the input image signal, the display device comprising:
a calculation circuit for calculating emission brightness of said image and generating a brightness level signal that represents a level of said emission brightness; and
a correction circuit for correcting the signal levels of the pixel signals included in said image signal for the respective emission colors based on said brightness level signal.

10. The display device according to claim 9, wherein said correction circuit comprises a first correction unit for correcting the signal levels of the pixel signals included in said image signal for the emission colors based on correction values stored in a correction value table.

11. The display device according to claim 10, wherein said calculation circuit generates said brightness level signal based on the image signal introduced to said first correction unit, and said first correction unit adjusts the correction values stored in said correction value table based on said brightness level signal.

12. The display device according to claim 10, wherein said correction circuit further comprises a second correction unit for correcting the signal levels of the pixel signals included in said image signal for the emission colors by multiplying a gain value and superimposing an offset value to each of the signal levels of said pixel signals.

13. The display device according to claim 9, wherein said correction circuit comprises a second correction unit for correcting the signal levels of the pixel signals included in said image signal for the emission colors by multiplying a gain value and superimposing an offset value to each of the signal levels of said pixel signals.

14. The display device according to claim 12, wherein said calculation circuit generates said brightness level signal based on the image signal outputted from said first correction unit, and said second correction unit adjusts at least one of said gain value and said offset value based on said brightness level signal.

15. The display device according to claim 9, wherein each said display cell group includes a red display cell to emit red light, a green display cell to emit green light, and a blue display cell to emit blue light, and said read, green and blue display cells emit the read light, green light and blue light in accordance with the signal levels of the pixel signals included in said image signal.
